(19) United States
(12) Patent Application Publication
(10) Pub. No.: US 2011/0148645 A1
(43) Pub. Date: Jun. 23, 2011

(54) LADDER WARNING SYSTEM

(76) Inventor: Richard Sarmiento, Danville, CA (US)

(21) Appl. No.: 12/646,080

(22) Filed: Dec. 23, 2009

(51) Int. Cl. G08B 21/00

(52) U.S. Cl. 340/665

(57) ABSTRACT

A ladder warning system comprises a pressure sensor attachable to a first step of a ladder; one or more warning devices; and a battery that distributes current to the one or more warning devices upon the pressure sensor sensing pressure exerted on the first step of the ladder.

### BACKGROUND OF THE INVENTION

The present invention generally relates to a ladder warning system, and more particularly relates to a warning system that warns a user when the user steps on the lowest step of the ladder as the user descends the ladder.

Presently, over 200,000 people are injured each year in ladder-related accidents, and many of these people are injured when they are descending a ladder. However, current ladder designs do not include a warning system that warns a user as he or she steps on the lowest step of the ladder.

As can be seen, there is a need for a warning system to warn a user as he or she steps on the lowest step of the ladder.

### SUMMARY OF THE INVENTION

In one aspect of the present invention, a ladder warning system comprises: a first pressure sensor attachable to a first step of a ladder; one or more warning device; and a battery that distributes current to the one or more warning devices upon the first pressure sensor sensing pressure exerted on the first step of the ladder.

In another aspect of the present invention, a ladder comprises: a first pressure sensor attached to a first step of the ladder; one or more warning devices; and a battery that distributes current to the one or more warning devices upon the first pressure sensor sensing pressure exerted on the first step of the ladder.

These and other features, aspects and advantages of the present invention will become better understood with reference to the following drawings, description and claims.

### BRIEF DESCRIPTION OF THE DRAWINGS

FIG. 1 shows a ladder warning system on a ladder in accordance with an embodiment of the present invention;

FIG. 2 shows a wiring diagram of the ladder warning system of FIG. 1 in accordance with an embodiment of the present invention; and

FIG. 3 shows a ladder warning system in an alternate configuration on a ladder in accordance with al alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a ladder warning system that provides both visual and audio warnings upon sensing pressure being placed by a user on the lowest step of a ladder.

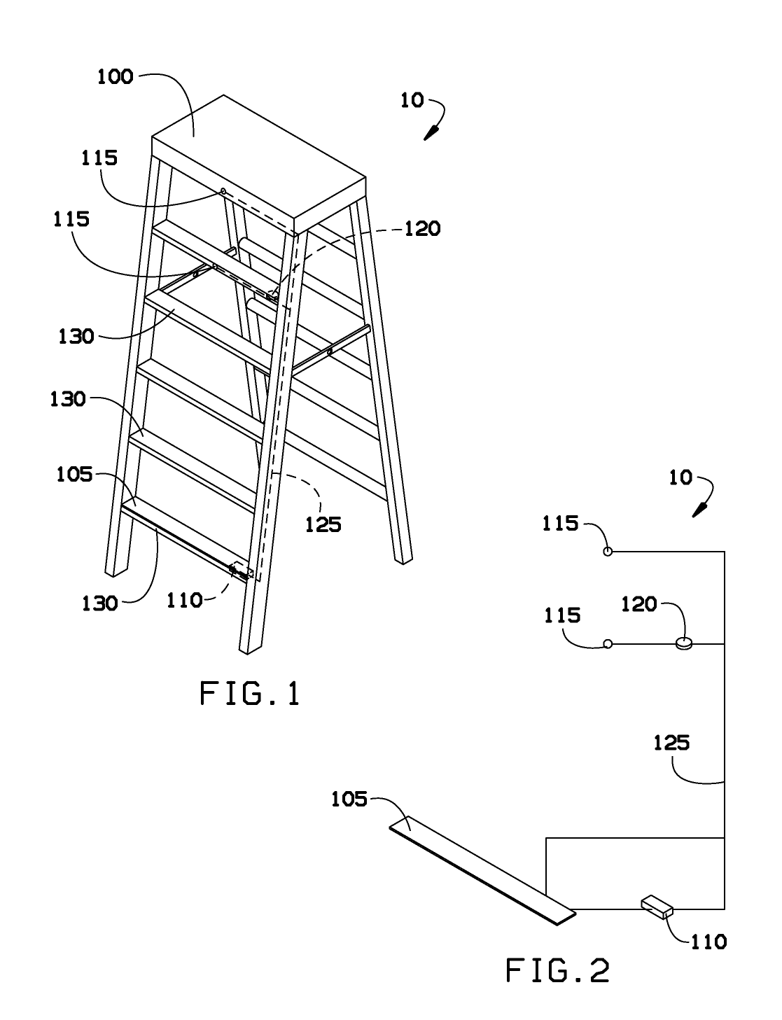

FIG. 1 shows a ladder warning system on a ladder in accordance with an embodiment of the invention. The ladder warning system 10 may comprise a pressure sensor 105, a battery 110, warning lights 115, a sound indicator 120, and wiring 125. As shown in FIG. 1, the pressure sensor 105 may be attached on top of a step 130 of the ladder 100, such as the lowest step on a ladder 100. The warning lights 115 may be placed on the ladder 100 so that when a user steps on the lowest step of the ladder 100, the warning lights 115 may be at eyelevel with the user. Similarly, the sound indicator 120 may also be placed on the ladder 100 such that when the user steps on the lowest step of the ladder 100, the sound indicator 120 may be at ear-level of the user. The battery 110 may be connected to the pressure sensor 105, the warning lights 115, and the sound indicator 120 via wiring 125.

FIG. 2 shows a wiring diagram of a ladder warning system 10 in accordance with an embodiment of the present invention. The pressure sensor 105 may be attached to a step of the ladder. When the pressure sensor 105 senses that pressure is being applied to the step of the ladder that it is attached to, such as when a user steps onto that step with his foot, the pressure sensor 105 may cause for the battery 110 to send current to the warning lights 115 and the sound indicator 120 via the wiring 125. The current may then cause the warning lights 115 to turn on, thereby emitting light or flashing light, and may also cause the sound indicator 120 to emit a sound, such as buzzing. The light emitted by the warning lights 115 and the sound emitted by the sound indicator 120 may serve to warn the user that he is at a certain level of the ladder.

In an exemplary embodiment of the present invention, the ladder warning system may be used to warn a user descending from a ladder that he is stepping on the lowest rung of the ladder and about to step off of the ladder. The pressure sensor 105 may be attached to the lowest step of the ladder, the warning lights 115 may be attached to the ladder at a position so that it is at eyelevel with a user when that user steps on the lowest step of the ladder. Similarly, the sound indicator 120 may be attached to the ladder at a position so that it is at ear level with the user when that user steps on the lowest step of the ladder. Thus, as the user descends the ladder, when the user steps on the lowest step of the ladder, the pressure sensor 105 may sense the user's weight and thus cause the sound indicator 120 to buzz and the warning lights 115 to turn on and flash, thus warning the user that he is about to step off of the ladder.

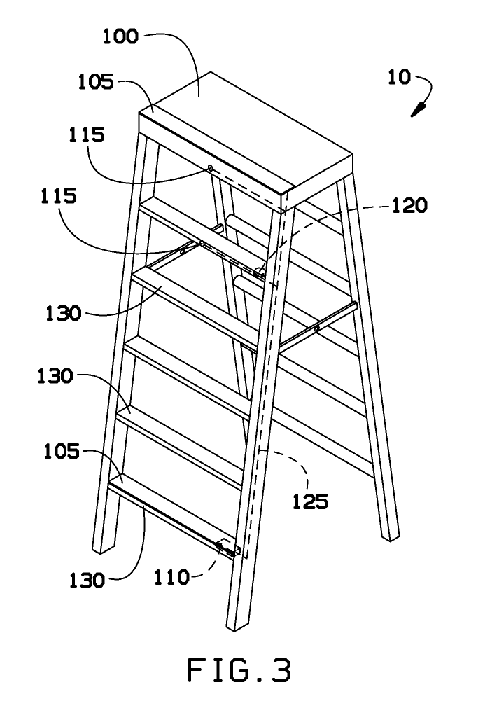

FIG. 3 shows the ladder warning system in an alternate configuration on a ladder in accordance with an alternate embodiment of the present invention. In the alternative exemplary embodiment of the present invention, the ladder warning system 10 may be used to warn a user that he is at the top of the ladder 100. The pressure sensor 105 may be attached to the topmost step of the ladder 100. When the pressure sensor 105 senses that the user is stepping onto the topmost step of the ladder, the pressure sensor 105 may cause the sound indicator 120 to turn on and emit a periodic buzzing sound and may further cause the warning lights 115 to turn on and flash.

In another alternative exemplary embodiment of the present invention, pressure sensors 105 may each be attached to the topmost step of the ladder and the lowest step of the ladder 100, thereby warning a user both when the user reaches the topmost step of the ladder 100 or when the user reaches the lowest step of the ladder 100.

In use, the warning lights may be light emitting diodes (LEDs) or any other methods of lighting. The sound indicator can be a buzzer, a speaker, or any other method of producing a warning sound. The wire connecting the components together can be contained within a wire harness.

It should be understood, of course, that the foregoing relates to exemplary embodiments of the invention and that modifications may be made without departing from the spirit and scope of the invention as set forth in the following claims.

We claim:

1. A ladder warning system comprising:
a first pressure sensor attachable to a first step of a ladder;
one or more warning devices; and
a battery that distributes current to the one or more warning devices upon the first pressure sensor sensing pressure exerted on the first step of the ladder, thereby causing the one or more warning devices to turn on.

2. The ladder warning system of claim 1 wherein the one or more warning devices comprise:
one or more warning lights connected to the pressure sensor; and
a sound indicator connected to the pressure sensor.

3. The ladder warning system of claim 1 wherein the first step of the ladder is a lowest step of the ladder.

4. The ladder warning system of claim 1 further comprising:
a second pressure sensor attachable to a second step of the ladder that, when pressed, causes the current to be distributed to the one or more warning devices.

5. The ladder warning system of claim 3, wherein the second step of the ladder is a highest step of the ladder.

6. A ladder comprising:
a first pressure sensor attached to a first step of the ladder;
one or more warning devices; and
a battery that distributes current to the one ore more warning devices upon the first pressure sensor sensing pressure exerted on the first step of the ladder.

7. The ladder of claim 6 wherein the one or more warning devices comprise:
one or more warning lights connected to the pressure sensor; and
a sound indicator connected to the pressure sensor.

8. The ladder of claim 6 wherein the first step of the ladder is a lowest step of the ladder.

9. The ladder of claim 6 further comprising:
a second pressure sensor attachable to a second step of the ladder that, when pressed, causes the current to be distributed to the one or more warning devices.

10. The ladder of claim 8, wherein the second step of the ladder is a highest step of the ladder.
